(19) United States
(12) Patent Application Publication
(10) Pub. No.: US 2019/0053520 A1
(43) Pub. Date: Feb. 21, 2019

(54) SYSTEMS AND METHODS OF FORMING SINGLE SERVE EDIBLE FOOD BAR

(71) Applicant: BarTendr Ventures LLC, Denver, CO (US)

(72) Inventor: Steve Leusner, West Knigston, RI (US)

(73) Assignee: BarTendr Ventures LLC, Denver, CO (US)

(21) Appl. No.: 15/763,105

(22) PCT Filed: Sep. 26, 2016
(86) PCT No.: PCT/US16/53747

§ 371 Date: Mar. 24, 2018

Related U.S. Application Data
(60) Provisional application No. 62/232,407, filed on Sep. 24, 2015.

(51) Int. Cl. A23L 7/126; A23P 20/10; A23P 30/10

(52) U.S. Cl. CPC A23L 7/126; A23V 2002/00; A23P 30/10; A23P 20/10

(57) ABSTRACT

The disclosure relates to system and methods of forming food bars, specifically, to systems and methods implementable on these systems, of forming single serve food bars in a relatively short timeframe.

### BACKGROUND

This disclosure is directed to a system and methods of forming food bars, specifically, to systems and methods implementable on these systems, of forming single serve food bars in a relatively short timeframe.

Various types of hand-held bars are known, as well as continuous and batch methods for their bulk manufacture. For example, cereal bars containing cereal dry mix ingredients are known, which are held together by a binder system. Typical binder systems may contain corn syrups and other ingredients (i.e., sugar, honey, etc.). The binder system is commonly heated before it is added to the cereal mix to assist blending. The cereal/binder matrix can then be sheeted or molded to form a layer before cooling and cutting steps. Normally, to achieve the required cohesion, the cereal matrix is compressed under rollers or other conventional cereal bar making equipment to form the bars. In some circumstances, mixes may be fed to an extruder or an auger in order to form bars.

Moreover, these portable foods are consumed as a meal substitute or snack and would therefore benefit greatly from the ability to be prepared on-demand at a relatively short timeframe and be individualized to the consumer's taste and nutritional needs.

Accordingly, systems and methods implementable on these systems, of forming single serve food bars in a relatively short timeframe would therefore be beneficial.

### SUMMARY OF THE DISCLOSURE

Disclosed, in various embodiments are systems and methods of forming in real-time, a single cereal bar.

In an embodiment, provided herein is a method of forming a single-serve edible bar comprising: providing a predetermined amount of discrete edible particulates; accretively coating the particulates with a colloidal binder; conveying the coated particulates to a molding means; and compressing the molding means over a predetermined period and temperature profile, for a predetermined pressure wherein the pressure varies with time in a non-continuous manner and the temperature varies non-linearly with time.

In another embodiment, provided herein is a system for forming a single-serve edible bar comprising: a molding module; means for subjecting the molding module to a predetermined pressure profile; means for subjecting the molding module to a predetermined temperature profile; means for loading and unloading the mold with a predetermined amount of particulate food; a plurality of sensors, configured to communicate time, temperature and pressure; and a processor in communication with the molding module, the means for subjecting the molding module to a predetermined pressure profile, the means for subjecting the molding module to a predetermined temperature profile, the means for loading and unloading the mold with a predetermined amount of particulate food, and the plurality of sensors, having a memory with a processor readable media thereon comprising a set of executable instructions configured to: load and/or unload the molding means; subject the molding means to the predetermined pressure profile; and subject the molding means to the predetermined temperature profile.

### BRIEF DESCRIPTION OF THE FIGURES

A better understanding of the system and methods of forming personalized single serve food bars in a relatively short timeframe, with regard to the embodiments thereof, reference is made to the accompanying drawings, in which like numerals designate corresponding elements or sections throughout and in which:

FIG. 1, is a graph showing the effect compression of molding module without additional heating;

FIG. 2 is a graph showing the effect on compression load as a function of time with an increase in temperature with Lucky Charms™ as food particulates;

FIG. 3, is a graph showing the effect on compression load as a function of time with an increase in temperature with Colden Grahams™ cereal as food particulates;

FIG. 4, is a graph showing the effect on compression load as a function of time with an increase in temperature with high protein content food particulates;

FIG. 5, is a graph showing the effect on compression load as a function of time with an increase in temperature up to 200° F. with generic food particulates; and

FIG. 6, is a graph showing the effect on compression load as a function of time with an increase in temperature up to 300° F. with generic food particulates.

### DETAILED DESCRIPTION

In several embodiments, provided herein are systems and methods implementable on these systems, of forming single serve food bars in a relatively short timeframe.

In an embodiment, provided here is a method of forming a single-serve (in other words, each bar alone, or a plurality of bars) edible bar comprising: providing a predetermined amount of discrete edible particulates (be they grated, shredded, comminuted, powdered, agglomerated food products or their combination etc.); accretively coating the particulates with a colloidal or soluble binder; conveying the coated particulates to a molding means; and compressing the molding means over a predetermined period and temperature profile, for a predetermined pressure wherein the pressure varies with time in a non-continuous manner and the temperature varies non-linearly with time.

In an embodiment, the molding means can be a chamber having separately, independently movable walls of various dimensions, for example a plurality of quadrilateral walls, independently movable sides, or facets in a frame. Top and bottom sides may also be movable along a longitudinal axis to allow the independently movable facet(s) or wall(s) to reduce the volume subsumed within the movable facet(s) or wall(s). Each of the movable facet(s) or wall(s) can be operably coupled to a load sensor and a compression actuator, allowing for each wall or facet to be compressed and the load on the actuator sensed and the load and pressure values communicated to a processing module. The processing module being in (electronic) communication with the load sensors and actuators for each of the independently moving wall(s) or facet(s).

The term “module” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time. In an embodiment, an electronic control unit of the systems disclosed and claimed, is the processing module.

Also, the term “communicate” (and its derivatives e.g., a first component “communicates with” or “is in communication with” a second component) and grammatical variations thereof are used to indicate a structural, functional, mechanical, electrical, optical, or fluidic relationship, or any combination thereof, between two or more components or elements. As such, the fact that one component is said to communicate with a second component is not intended to exclude the possibility that additional components can be present between, and/or operatively associated or engaged with, the first and second components. Furthermore, the term “electronic communication” means that one or more components of the systems for forming single serve food bars in a relatively short timeframe described herein, are in wired or wireless communication or internet communication so that electronic signals and information can be exchanged between the components.

The discrete edible particulate(s) used in the systems and methods implementable on these systems, of forming single serve food bars in a relatively short timeframe provided herein can comprise: a processed cereal piece, an extruded cereal piece, rolled cereals, puffed grains, toasted flakes, a baked cereal piece, a fruit piece, a dairy-containing particulate, an agglomerate comprising one or more of the foregoing or a combination thereof. “Processed cereal piece” can be a particulate formed by the process used to produce the RTE cereal, that process produces flaked pieces, puffed cereal grain kernels, or puffed dough pieces, extruded dough pieces, or in another embodiment, baked pieces, nuggets or rolled grain pieces. A person skilled in the art would recognize that the process used for making any RTE cereal pieces, does not preclude the use of the disclosed methods, such as in another embodiment, in a process for manufacturing a ready-to-eat food bar comprising preparing a dry mixture of particles or flakes of one or more cooked-extruded bases, comprising in one embodiment an amylaceous material or milk solids, or a combination thereof, mixing the dry mixture with a colloidal binder (referring to refers to composite particles having a number average particle size ranging from 0.05 to 3 μm), comprising sugar, or milk solids or a binding agent or a mixture thereof, and forming the obtained mass into a bar shape using the systems described herein. The colloidal binder can comprise cellulose, microcrystalline cellulose, cocoa bran, corn bran, oat bran, oat fiber, apple pulp, pectin, psyllium, rice bran, sugar beet pulp, wheat bran, soybean fiber, hydrocolloids, pea fiber, wheat fiber, inulin, hydrolyzed inulin, guar gum, hydrolyzed guar gum, β-2-1-fructofuranose materials, sugar, corn syrup, starch, dextrins, xanthan, sugar alcohols, or mixtures comprising one or more of the foregoing

The coating used in the systems and methods implementable on these systems, of forming single serve food bars in a relatively short timeframe provided herein can further comprise a liquid a binder, which, under certain embodiments can be used to couple the colloidal mixture to the edible particulate. The liquid binder can be used in the process of making the edible particulate itself. In an embodiment, the term “liquid binder,” refers to a syrup composition that can act as an adhesive for combining relatively dry ingredients and temporarily causing the colloidal binder to adhere to the edible particulate. In another embodiment, no colloidal binder is used and only a liquid binder is used. Depending on the edible particulates composition, the thickness and composition of the liquid binder (e.g., dextrin syrup) can be chosen and the accretive coating be employed to obtain the proper behavior once compacted or compressed under thermal treatment using the systems described herein

In one embodiment, the edible particulate used in the systems and methods implementable on these systems, of forming single serve food bars in a relatively short timeframe provided herein can be lightly contacted with a tackifying liquid binder, after which time a colloidal binder can be added, which then evenly coats and adheres (or if the glass transition (T_{g}) of an amorphous colloidal binder is locally exceeded and is used) to the edible particulate.

Once the edible particulates has been tackified by treatment with a liquid such as oil, water (including steam in one embodiment, or local surface heating), sugar syrup, corn syrup, soluble fiber solution, molten wax, emulsifiers, gum solutions, etc. the fiber may be applied to surface where it will adhere. The colloidal binder can then be activated or swollen in an even coating/layer by the subsequent accretive addition of a water (or other plasticizer)—containing syrup consisting of water, sugars, soluble fibers, etc. or a combination of one or more plasticizer and the foregoing, in order to create a, accretively formed finished coat on the food particulate, which can then be dried, yielding an accretively coated edible particulate. The dried edible particulate can then be packaged in a pod, sachet, casing, or other discrete packaging sufficient for forming a single serve edible food bar.

Accordingly and in an embodiment, the step of coating used in the systems and methods implementable on these systems, of forming single serve food bars in a relatively short timeframe provided herein can comprise adding the edible particulates into coating means; separately adding the colloidal coating matter and an adhesive liquid to said coating means, at liquid levels which locally reduce the local glass transition temperature (T_{g}) (in other words, the T_{g} of the surface layer only, at the nanometer scale) of the particulate and/or the colloidal coating matter, below the operating temperature of the coating means (in other words, the operating temperature of the coating means, e.g., a tumbler, is above the surface T_{g} of the edible particulate and/or the colloidal binder), without inducing collapse of the bulk mass of the edible particulates or the bulk mass of the colloidal coating matter; and in a continuous manner, accritively increasing the content of the colloidal coating matter on the surface coating of the particulates in the coating means, wherein the colloidal coating matter is added at a level of between about 5% and about 50% (w/w). The term “accretively” refers to the gradual deposition of the coating on the cereal piece over time and/or distance resulting in accretion or build-up of the coating on the cereal piece.

It is contemplated that, in certain embodiments, the coating matter added accretively is added as fry matter, with moisture content of less than about 7% and not in a slurry. In other embodiment, the moisture content of the dry coating matter added is configured to reduce the glass transition (Tg) of the otherwise amorphous coating to be lower than the processing temperature, with the cereal piece's Tg being higher than the processing temperature.

The term “tackified” as used in connection with the coating process of the edible particulates, refers in an embodiment to the modification of the surface of the edible particulate making it more amenable to absorption of colloidal binder, or liquid binder according to the disclosed methods. So, applying liquid which can be configured to favorably wet (or, in other words, plasticize) both the edible particulate and the colloidal binder according to the disclosed methods, will tackify the edible particulate. In another embodiment, locally (referring to the surface of an edible particulate) exceeding the T_{g} of An edible particulate, creating a rubbery state on the surface of the piece likewise qualifies as tackifying the particulate according to the disclosed methods. In addition, tackifying the surface of the edible particulate, or the surface of the added colloidal binder can be done by making the surface more amenable to adhesion. The term “adhesion” and its grammatical uses (e.g., adheres) refers to the holding together of two bodies by interfacial forces or mechanical interlocking on a scale of micrometers or less. For example, by chemical adhesion, or through interfacial adhesion. The term “chemical adhesion” refers in one embodiment to adhesion in which two bodies are held together at an interface by ionic, vander Waals, or covalent bonding between molecules on either side of the interface. The term “interfacial adhesion” refers in another embodiment to adhesion in which interfaces between phases or components are maintained by intermolecular forces, chain entanglements, or both, across the interfaces. In an embodiment, the accretive coating of the edible particulates used in the systems and methods implementable on these systems, of forming single serve food bars in a relatively short timeframe provided herein can be due to interfacial adhesion formed by the fusion of the edible particulate surface having reduced surface viscosity due to locally exceeding the glass transition temperature (T_{g}), with the reduced surface viscosity of the colloidal binder.

Alternatively, no adhesive liquid is added to the coating means prior to introduction of the colloidal binder in the coating means. Thus, the coating means is contacted with hot air in such a way that the surface of the edible particulate exceeds the local (or surface) T_{g}, with viscosity of the surface falling about 2-6 orders of magnitude, for example, from about 10¹⁴ to about 10⁹ cPas, thereby allowing cohesion of the colloidal binder onto the locally visco-elastic (or rubbery) surface of the edible particulate. A person skilled in the art would recognize that there are many methods allowing for locally exceeding T_{g} without collapsing the whole (in other words, the bulk) of the edible particulate. All methods which increase temperature locally to the point where the environment temperature (in the processing environment, like the coating means and or the molding module) is higher than the phase-corresponding T_{g} are contemplated as encompassed within the scope of the disclosed technology. In one embodiment, molecular weight average, concentration of components, relative humidity, presence of other plasticizers, process manipulation (e.g. steam injection) and the like or their combination, can be used to tackify the surface of the edible particulate, allowing for adherence of the compositions of the disclosed technology and are used in the disclosed methods implementable on the disclosed systems. The colloidal binder (or in an embodiment, soluble binder) coated piece may then be optionally covered with a sealer coat (soluble colloidal binder, sugar, etc,) to facilitate compacting in the molding module.

The term “collapse” refers to the inability of the edible particulate to support its own bulk weight, or its own volume. Collapse may be restricted to an external layer of the edible particulate, which can be in the range of 1 to about 10³ μm. A person skilled in the art would realize that the ability of colloidal binder to adhere to the edible particulate does not necessarily depend on the ability of the adhesive liquid as described herein, to plasticize the edible particulate. The term “plasticizer”, refers in an embodiment to the ability of the adhesive liquid to reduce T_{g}, or in another embodiment, to increase the free volume of the amorphous state of the surface layer of the edible particulate.

Once coated with the colloidal (or soluble) binder, the coated particulates can be dehydrated to an equilibrium moisture content of between about 3% and about 7% (w/w) and removed from the coating means, the coated edible particulates can be configured to have an amorphous surface (for example, using rapid drying at relatively high temperatures), that when used with the systems disclosed and claimed herein and exposed to the temperature profile disclosed, will exhibit a consolidation (T_{c}) point when the T_{g} of the coated edible particulate is exceeded, and the particulates compressed or otherwise compacted, form three dimensional (in the bulk volume) bond concentration that exceeds the 3D bond percolation threshold of the bulk and the mass of edible particulates begin to exhibit the physico-chemical characteristics of a single mass, rather than a combination of discrete edible particulates. Upon further increase of the temperature, the bulk will start flowing, exhibiting a flow point (T_{f}).

Accordingly, the molding means used in the systems and methods implementable on these systems, of forming single serve food bars in a relatively short timeframe provided herein can be compressed, or compacted at a first predetermined pressure for a first predetermined period and a second predetermined pressure for a second period. The compression of the molding module can be carried out under heating and the first compression period can be limited by arriving at the consolidation point (T_{c}) described herein. Using the load sensor(s) on the pressure actuator(s) operably coupled to the independently movable wall(s) or facet(s) of the molding module, and upon determination by the processing module that the consolidation point has been reached, the actuator(s) can be configured to change the compression pressure imposed on the wall(s) or facet(s) compressing the bulk, and the pressure imposed can be increased or decreased to achieve the desired bulk density of the finished single-serve edible bar.

The time for reaching consolidation point (T_{c}), can be dependent on various factors, for example, the composition of the edible particulate, its size and size distribution, the type, concentration (w/w), and size distribution of the colloidal binder, the rate of increase in temperature of the molding module, its heat transfer coefficient, the pressure imposed on the wall(s) or facet(s) or a combination of factors comprising one or more of the foregoing.

The temperature with which the molding module is heated, can be configured to increase at a rate represented by the formula:

Tₜ=T₀+kₜ ln(t) (Equ. 1)

wherein
T₀ is between about 50° F. and about F° C.,
kₜ is between about 50 and about 75 (dimensionless)
t is time (min.)

The molding module can be heated using heating means operably coupled to some or all of the independently movable walls or facets. For example, the wall(s) or facet(s) can be a resistor to an electric current coupled to a variable current source, or in another example, be operably coupled to a heating element, or be double jacketed and be in fluid communication with a heating liquid (e.g., oil, steam). In addition, the molding module can be operably coupled to means for cooling.

The pressure applied using the actuators described herein, can be varied along the time line after achieving the consolidation point (T_{c}) and be reduced or increased in a predetermined manner to maintain a specific, predetermined bulk density of the finished, single-serve edible bar.

In an embodiment, when referring to “relatively short time frame”, the methods provided, implemented in the systems described are configured to provide a personalized, single-serve, ready to eat edible bar at a time frame of between about 1 min. and about 15 min. Accordingly and in an embodiment, provided herein is a system for forming a single-serve edible bar comprising: a molding module; means for subjecting the molding module to a predetermined pressure profile; means for subjecting the molding module to a predetermined temperature profile; means for loading and unloading the mold with a predetermined amount of particulate food; a plurality of sensors, configured to communicate time, temperature and pressure; and a processor in communication with the molding module, the means for subjecting the molding module to a predetermined pressure profile, the means for subjecting the molding module to a predetermined temperature profile, the means for loading and unloading the mold with a predetermined amount of particulate food, and the plurality of sensors, having a memory with a processor readable media thereon comprising a set of executable instructions configured to: load and/or unload the molding means; subject the molding means to the predetermined pressure profile; and subject the molding means to the predetermined temperature profile.

The molding means (interchangeable with molding module as described herein), used in the systems for forming a single-serve edible bar provided herein, can comprise an elongated housing or chamber, with at least one movable section (e.g., wall, or facet) relative to the housing's longitudinal axis or transverse axis. The movable section configured to reduce the chamber volume. Further, the means for subjecting the molding module to a predetermined temperature profile used in the systems for forming a single-serve edible bar provided herein, can comprise a heating element operably coupled to the housing, the heating element configured for heating and/or cooling the housing or chamber at a predetermined rate to a predetermined level. Moreover, the means for subjecting the molding module to a predetermined pressure profile used in the systems for forming a single-serve edible bar provided herein, can comprise an actuator operably coupled to the at least one movable section of the housing. While the term actuator is herein used to designate devices of the kind discussed above, essentially similar mechanisms are variously known in the art as fluid cylinders, hydraulic jacks, linear fluid motors or by still other names and the term actuator as used herein should be understood to refer to all such devices which have the basic capabilities discussed above. For example, the actuator can be a motor driver operably coupled to a screw gear having a shaft hinging element operably coupled to a movable section of the mold.

Furthermore, the processor is configured to subject the housing to a first pressure and temperature profile until receiving a load value from the plurality of sensors indicating a consolidation point (T_{c}), while simultaneously altering the pressure and/or temperature of the molding module.

Further provided, is a single serve edible bar formed according to the methods described herein, as implemented in the systems provided.

### EXAMPLES

### Example 1

### No Added Heat

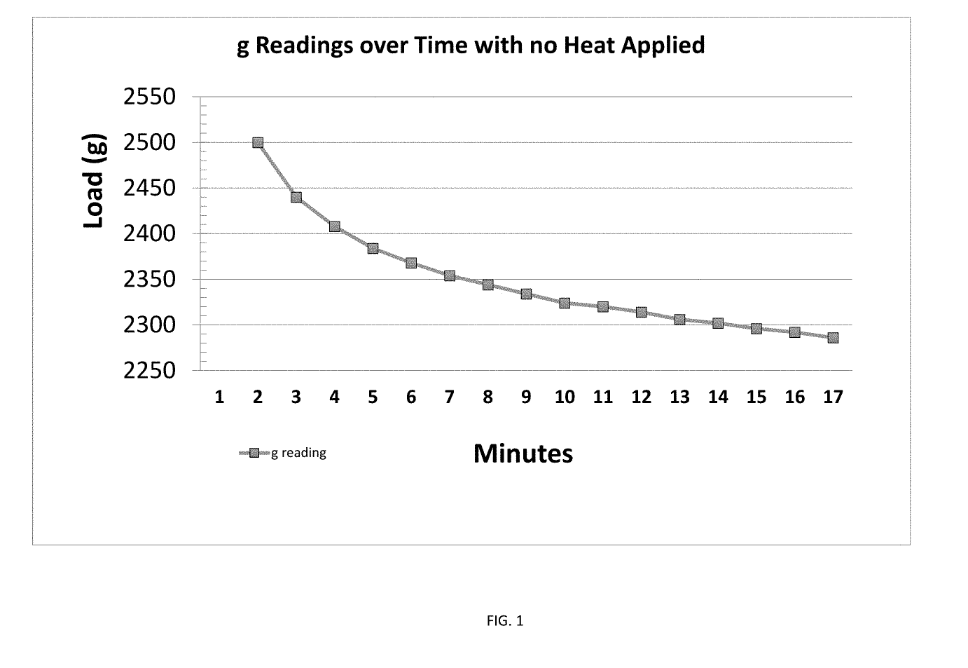

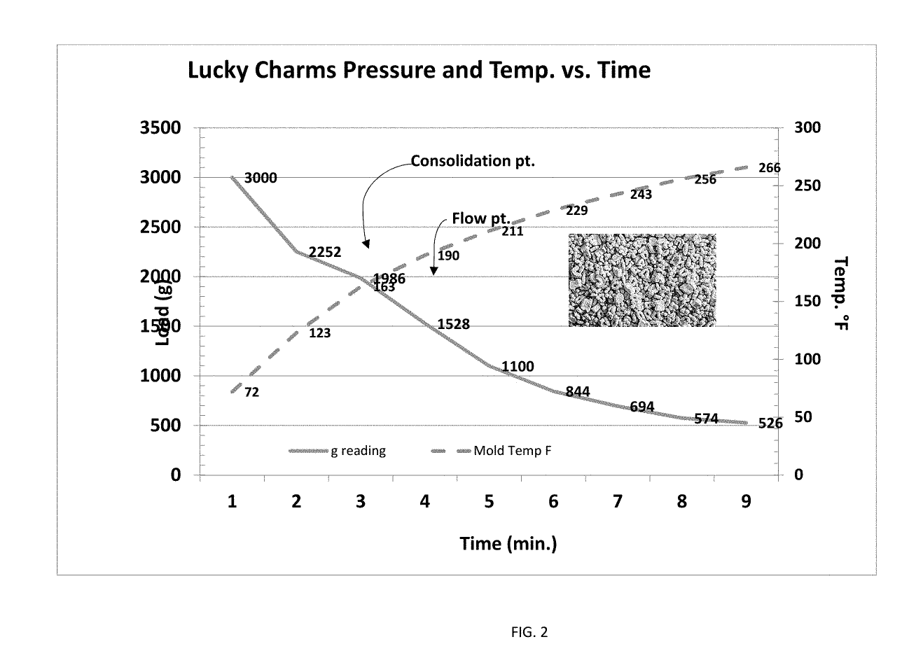

Turning to FIG. 1, illustrating the compression of a cereal-based edible particulates in a molding module as described hereinabove, without thermally treating the molding means. As illustrated, the load experienced by the actuator seems to decay continuously, without exhibiting any consolidation or flow pointe (T_{c}, T_{f} respectively, see e.g., FIG. 2). Absent the consolidation point indication, the edible bar was not formed and upon opening the mold, the particulates disintegrated.

### Example 2

### Lucky Charms® Cereal Particulates, Heat and Pressure

Turning now to FIG. 2, illustrating the effect of time and temperature at a predetermined pressure on the load experienced by the pressure actuator using the systems described hereinabove. As illustrated, raising the temperature non-linearly according to EQU. 1, where T₀ is 66° F. and kₜ is 90. As illustrated, the consolidation point (Tc), exhibited as a sudden drop in the loads on the actuator, is achieved after about 2 minutes at a temperature of about 123° F. Flow point is reached at about a minute later, at a temperature of about 166° F. A bar was formed with good integrity. The lucky charms cereal particulates were coated with soluble/colloidal powder of hydrolyzed inulin, then transferred to the molding module.

### Example 3

### Golden Grahams® Cereal Particulates, Heat and Pressure

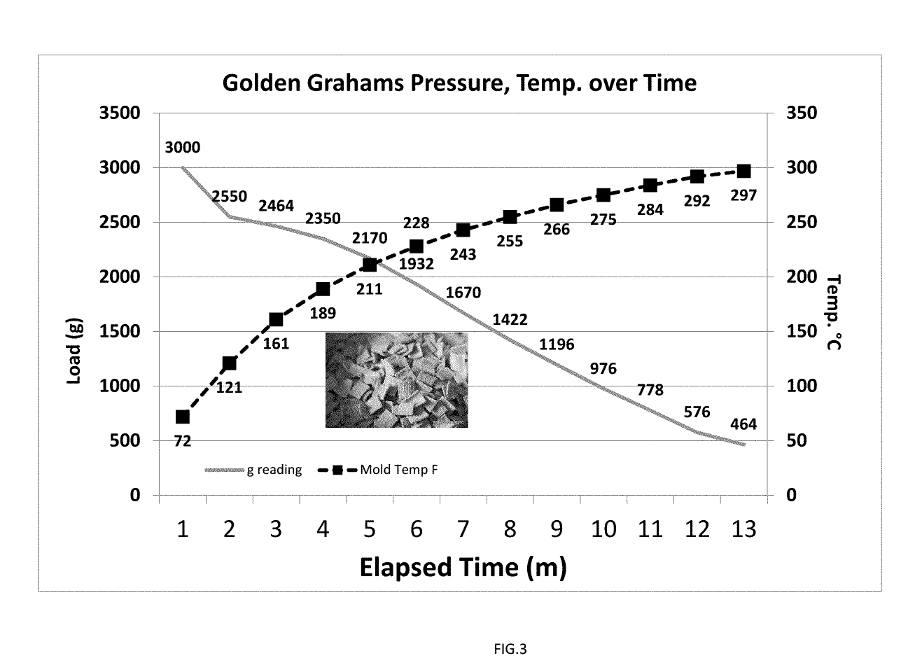

Turning now to FIG. 3, illustrating the effect of time and temperature at a predetermined pressure (3000 g) on the load experienced by the pressure actuator using the systems described hereinabove. As illustrated, raising the temperature non-linearly according to EQU. 1, where T₀ is 64.8° F. and kₜ is 90.97. As illustrated, the consolidation point (Tc), exhibited as a sudden drop in the loads on the actuator, is achieved after about 2 minutes at a temperature of about 123° F. Flow point is reached at 4 minutes, at a temperature of about 185° F. A bar was formed with good integrity. The Golden Graham cereal particulates were used “as is” from store, with a rapidly cooled sugar melt coating then transferred to the molding module and compacted.

When forming the bar, the system can be configured to reduce the applied pressure by the actuator after reaching the consolidation point, while maintaining the mold temperature below the temperature corresponding to the flow point (T_{f}), and begin cooling the mold, thereby reducing the time to achieve a single serve monolithic bar with good integrity.

### Example 4

### High Protein Content (90%) Particulates, Heat and Pressure

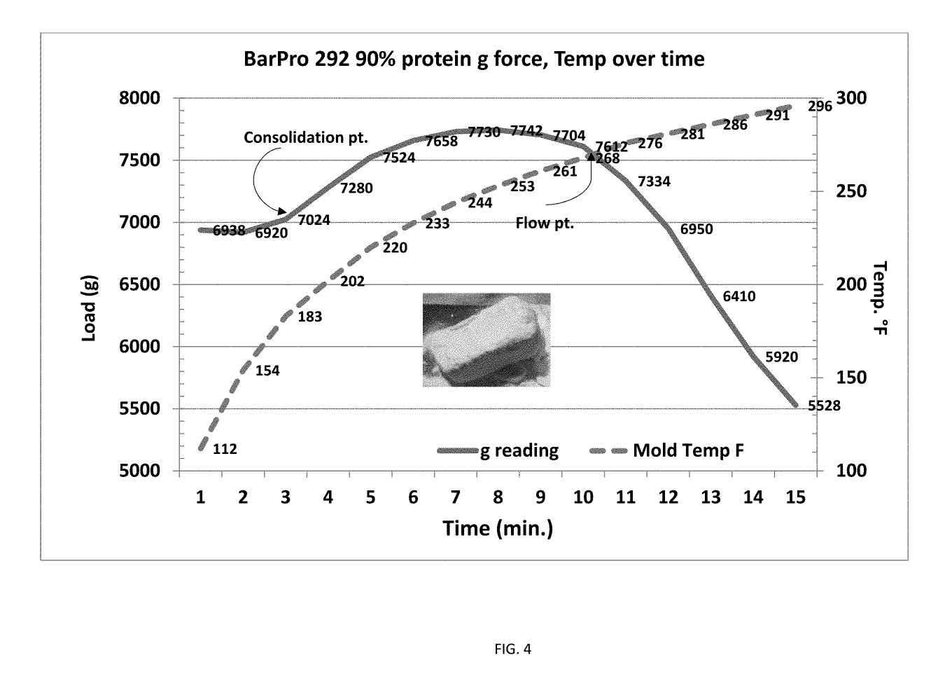

Turning now to FIG. 4, illustrating the effect of time and temperature at a predetermined pressure on the load experienced by the pressure actuator using the systems described hereinabove. As illustrated, raising the temperature non-linearly according to EQU. 1, where T₀ is 101.5° F. and kₜ is 72. As illustrated, the consolidation point (Tc), exhibited as a sudden increase in the loads on the actuator, ostensibly due to unraveling of tertiary and quaternary structures, and increase in volume resulting therefrom, is achieved after about 2.5 minutes at a temperature of about 175° F. Flow point is reached at about eight minutes later, at a temperature of about 265° F. A bar was formed with good integrity. The particulates were used “as is” from store, then transferred to the molding module.

When forming the bar, the system can be configured to increase the applied pressure by the actuator after reaching the consolidation point, while increasing the mold temperature above the temperature corresponding to the flow point (T_{f}) at a faster rate, and upon the processing module receiving indication that the flow point has been achieved, begin cooling the mold, thereby reducing the time to achieve a single serve monolithic bar with good integrity.

### Example 5

### Effect of Heating Rate at Constant Pressure

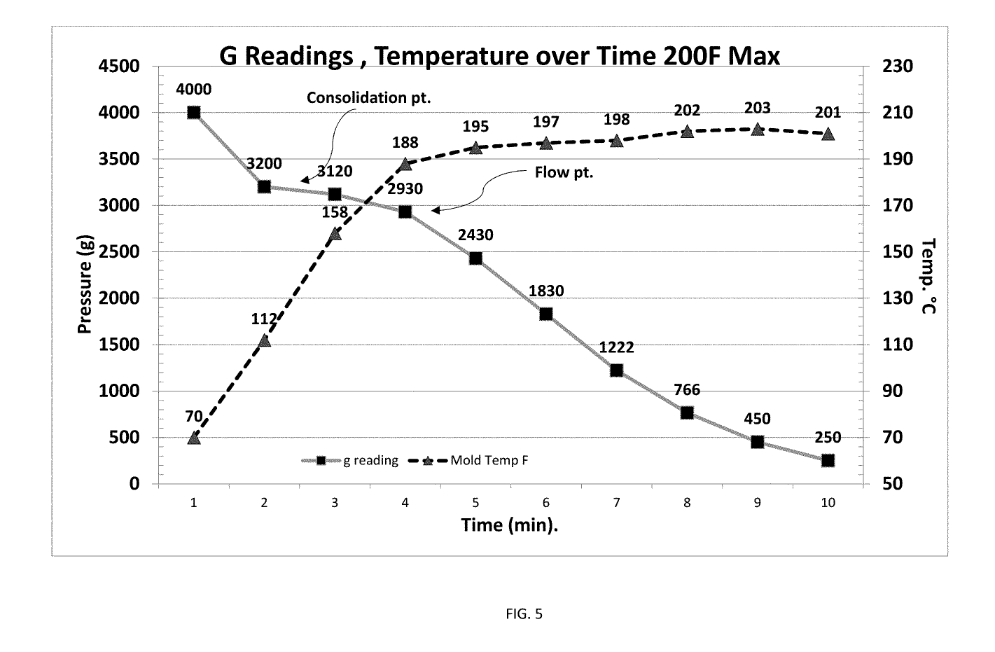

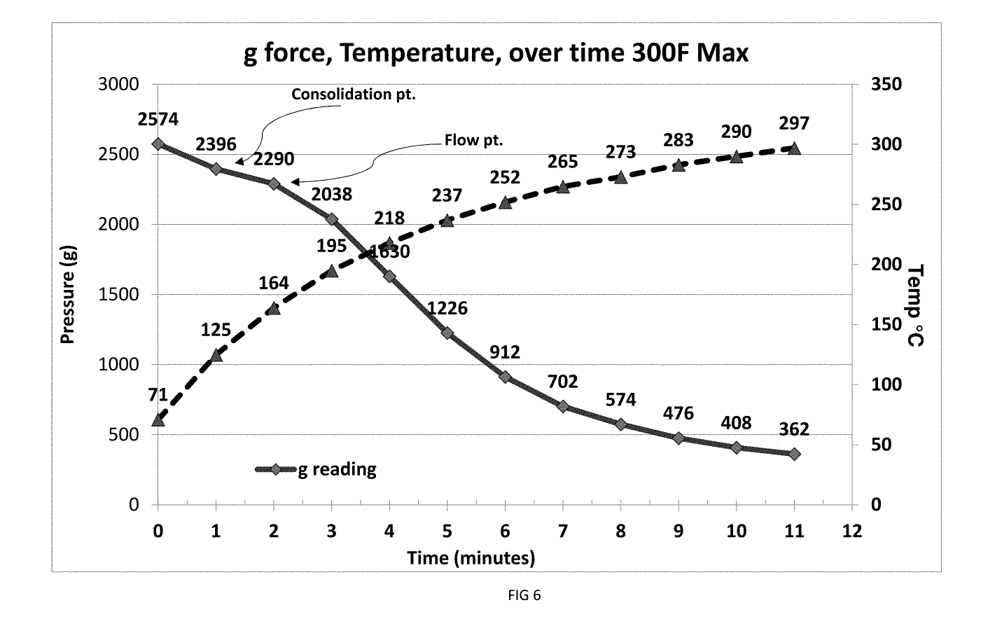

Turning now to FIGS. 5, and 6, illustrating the effect of max temperature and therefore heating rate, on achieving consolidation point (Tc) and flow point with as the edible particulate source. As illustrated in FIG. 5, raising the temperature non-linearly up to 200° F. according to EQU. 1, where T₀ is 76.1° F. and kₜ is 67. As illustrated, the consolidation point (Tc), exhibited as a sudden drop in the loads on the actuator, is achieved after about 2 minutes at a temperature of about 112° F. Flow point is reached at about two minutes later, at a temperature of about 188° F. A bar was formed with good integrity. The particulates were coated with soluble powder of hydrolyzed inulin, then transferred to the molding module

As illustrated in FIG. 6, raising the temperature non-linearly up to 300° F. according to EQU. 1, where T₀ is 65.65.1° F. and kₜ is 94. As illustrated, the consolidation point (Tc), exhibited as a sudden drop in the loads on the actuator, is achieved after about 1 minute at a temperature of about 125° F. Flow point is reached at about one minute later, at a temperature of about 170° F. A bar was formed with good integrity. The particulates were coated with soluble powder of hydrolyzed inulin, then transferred to the molding module.

Since both the consolidation point (Tc) and Flow point (Tf) represent cooperative bulk events in the molding module, and considering the substantial difference in the heating rates (kₜ) it can be reasonable to expect some hysteresis between the behaviors of the bulk particulates under the two heating regimens. That difference is used in an embodiment to provide a preferred heating profile of the molding module to reduce the time for obtaining the single serve monolithic bar.

The term “coupled”, including its various forms such as “operably coupling”, “coupling” or “couplable”, refers to and comprises any direct or indirect, structural coupling, connection or attachment, or adaptation or capability for such a direct or indirect structural or operational coupling, connection or attachment, including integrally formed components and components which are coupled via or through another component or by the forming process. Indirect coupling may involve coupling through an intermediary member or adhesive, or abutting and otherwise resting against, whether frictionally or by separate means without any physical connection.

“Combination” is inclusive of blends, mixtures, alloys, reaction products, and the like. Furthermore, the terms “first,” “second,” and the like, herein do not denote any order, quantity, or importance, but rather are used to denote one element from another.

The terms “a”, “an” and “the” herein do not denote a limitation of quantity, and are to be construed to cover both the singular and the plural, unless otherwise indicated herein or clearly contradicted by context. The suffix “(s)” as used herein is intended to include both the singular and the plural of the term that it modifies, thereby including one or more of that term (e.g., the facet(s) includes one or more facet).

Reference throughout the specification to “one embodiment”, “another embodiment”, “an embodiment”, and so forth, means that a particular element (e.g., feature, structure, and/or characteristic) described in connection with the embodiment is included in at least one embodiment described herein, and may or may not be present in other embodiments. In addition, it is to be understood that the described elements may be combined in any suitable manner in the various embodiments.

The term “selectably” as used when referring to the selectable heating and pressure profile based on the nature of the edible particulates, means the actuators and heating/cooling means are capable of being activated without affecting other components of the system.

The term “about”, when used in the description of the technology and/or claims means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. In general, an amount, size, formulation, parameter or other quantity or characteristic is “about” or “approximate” whether or not expressly stated to be such and may include the end points of any range provided including, for example ±25%, or ±20%, specifically, ±15%, or ±10%, more specifically, ±5% of the indicated value of the disclosed amounts, sizes, formulations, parameters, and other quantities and characteristics.

One or more components may be referred to herein as “configured to,” “configured by,” “configurable to,” “operable/operative to,” “adapted/adaptable,” “able to,” “conformable/conformed to,” etc. The terms (e.g. “configured to”) can generally encompass active-state components and/or inactive-state components and/or standby-state components, unless context requires otherwise.

Furthermore, for the purposes of the present disclosure, directional or positional terms such as “top”, “bottom”, “upper,” “lower,” “side,” “front,” “frontal,” “forward,” “rear,” “rearward,” “back,” “trailing,” “above,” “below,” “left,” “right,” “horizontal,” “vertical,” “upward,” “downward,” “outer,” “inner,” “exterior,” “interior,” “intermediate,” “posterior”, “anterior”, “apically”, “basally” etc., are merely used for convenience in describing the various embodiments of the present invention.

Accordingly and in an embodiment, provided herein is a method of forming a single-serve edible bar comprising: providing a predetermined amount of discrete edible particulates; accretively coating the particulates with a colloidal binder; conveying the coated particulates to a molding means; and compressing the molding means over a predetermined period and temperature profile, for a predetermined pressure wherein the pressure varies with time in a non-continuous manner and the temperature varies non-linearly with time, wherein (i) the discrete edible particulate comprises: an extruded cereal piece, rolled cereals, puffed grains, toasted flakes, a baked cereal piece, a fruit piece, a dairy-containing particulate, an agglomerate comprising one or more of the foregoing or a combination thereof, (ii) the colloidal binder comprises cellulose, microcrystalline cellulose, cocoa bran, corn bran, oat bran, oat fiber, apple pulp, pectin, psyllium, rice bran, sugar beet pulp, wheat bran, soybean fiber, hydrocolloids, pea fiber, wheat fiber, inulin, hydrolyzed inulin, guar gum, hydrolyzed guar gum, β-2-1-fructofuranose materials or mixtures comprising one or more of the foregoing, (iii) the coating further comprises a liquid, wherein (iv) the step of coating comprises: adding the particulates into a coating means; separately adding the colloidal coating matter and an adhesive liquid to said coating means, at levels which locally reduce the glass transition temperature (T_{g}) of the particulate and/or the colloidal coating matter, below the operating temperature of the coating means, without inducing collapse of the particulates or the colloidal coating matter; and in a continuous manner, accritively increasing the content of the colloidal coating matter on the surface coating of the particulates in the coating means, wherein the colloidal coating matter is added at a level of between about 5% and about 50% (w/w), wherein (v) the step of positioning the coated particulates is preceded by a step of drying the coated particulates to a moisture level of between about 3% to about 7% (w/w), wherein (vi) the step of positioning the coated particulates comprises pneumatically conveying the coated particulates from the coating means to the mold, and/or (vii) mechanically conveying the coated particulates from the coating means to the mold, wherein (viii) the molding means is compressed at a first predetermined pressure for a first predetermined period and a second predetermined pressure for a second period, wherein (ix) the temperature increases at a rate represented by the formula: Tₜ=T₀+kₜ ln(t) and wherein T₀ is between about 50° C. and about 125° C., while kt is between about 50 and 75 minute⁻¹, wherein (x) the pressure in the first period is higher than the pressure in the second period, or (xi) the pressure in the first period is lower than the pressure in the second period, and wherein (xii) the coated particulates are conveyed to the mold in a pod, a canister, a compartment, a sachet, a bag or a housing.

In another embodiment, provided herein is a system for forming a single-serve edible bar comprising: a molding module; means for subjecting the molding module to a predetermined pressure profile; means for subjecting the molding module to a predetermined temperature profile; means for loading and unloading the mold with a predetermined amount of particulate food; a plurality of sensors, configured to communicate time, temperature and pressure; and a processor in communication with the molding module, the means for subjecting the molding module to a predetermined pressure profile, the means for subjecting the molding module to a predetermined temperature profile, the means for loading and unloading the mold with a predetermined amount of particulate food, and the plurality of sensors, having a memory with a processor readable media thereon comprising a set of executable instructions configured to: load and/or unload the molding means; subject the molding means to the predetermined pressure profile; and subject the molding means to the predetermined temperature profile, wherein (xiii) the molding means comprises an elongated housing with at least one movable section relative to the housing's longitudinal axis or transverse axis, wherein (xiv) the means for subjecting the molding module to a predetermined temperature profile comprises a heating element operably coupled to the housing, the heating element configured for heating and/or cooling the housing, wherein (xv) the means for subjecting the molding module to a predetermined pressure profile comprises an actuator operably coupled to the at least one movable section of the housing, wherein (xvi) the processor is configured to increases the housing temperature at a rate represented by the formula: Tₜ=T₀+kₜ ln(t) and wherein T₀ is between about 50° C. and about 125° C., while k (min.⁻¹) is between about 50 and about 75 and t is time (min.), wherein (xvii) the processor is configured to subject the housing to a first pressure and temperature profile until receiving a load value from the plurality of sensors indicating a consolidation point, and altering the pressure and/or temperature.

In yet another embodiment, provided herein is a single serve cereal bar formed by the systems and methods described herein.

While particular embodiments of the system and methods of forming personalized single serve food bars in a relatively short timeframe; have been described, alternatives, modifications, variations, improvements, and substantial equivalents that are or may be presently unforeseen may arise to applicants or others skilled in the art. Accordingly, the appended claims as filed and as they may be amended, are intended to embrace all such alternatives, modifications variations, improvements, and substantial equivalents.

1. A method of forming a single-serve edible bar comprising:
a. providing a predetermined amount of discrete edible particulates;
b. accretively coating the particulates with a colloidal or soluble binder materials;
c. conveying the coated particulates to a molding means; and
d. compressing the molding means over a predetermined period and temperature profile, for a predetermined pressure wherein the pressure varies with time in a non-continuous manner and the temperature varies non-linearly with time.

2. The method of claim 1, wherein the discrete edible particulate comprises: an extruded cereal piece, rolled cereals, puffed grains, toasted flakes, a baked cereal piece, a fruit piece, a dairy-containing particulate or powder, an agglomerate comprising one or more of the foregoing or a combination thereof.

3. The method of claim 2, wherein the colloidal and/or soluble binder comprises cellulose, microcrystalline cellulose, cocoa bran, corn bran, oat bran, oat fiber, apple pulp, pectin, psyllium, rice bran, sugar beet pulp, wheat bran, soybean fiber, hydrocolloids, pea fiber, wheat fiber, inulin, hydrolyzed inulin, guar gum, soluble corn bran, sucrose, corn syrup, and the like coating materials. hydrolyzed guar gum, β-2-1-fructofuranose materials or mixtures comprising one or more of the foregoing.

4. The method of claim 3, wherein the coating further comprises a liquid.

5. The method claim 4, wherein the step of coating comprises:
a. adding the particulates into a coating means;
b. separately adding the colloidal and/or soluble coating matter and an adhesive liquid to said coating means, at levels which locally reduce the glass transition temperature (T_{g}) of the particulate and/or the colloidal coating matter, below the operating temperature of the coating means, without inducing collapse of the particulates or the colloidal coating matter; and
c. in a continuous manner, accretively increasing the content of the colloidal and/or soluble coating matter on the surface coating of the particulates in the coating means, wherein the colloidal coating matter is added at a level of between about 5% and about 50% (w/w).

6. The method of claim 5, wherein the step of positioning the coated particulates is preceded by a step of drying the coated particulates to a moisture level of between about 3% to about 7% (w/w).

7. The method of claim 6, wherein the step of positioning the coated particulates comprises pneumatically conveying the coated particulates from the coating means to the mold.

8. The method of claim 6, wherein the step of positioning the coated particulates comprises mechanically conveying the coated particulates from the coating means to the mold.

9. The method of claim 8, wherein the molding means is compressed at a first predetermined pressure for a first predetermined period and a second predetermined pressure for a second period.

10. The method of claim 9, wherein the temperature increases at a rate represented by the formula: Tₜ=T₀+kₜ ln(t) and
wherein T₀ is between about 50° C. and about 125° C.,
while k is between about 50 min.⁻¹ and about 100 min.⁻¹.

11. The method of claim 9 or 10, wherein the pressure in the first period is higher than the pressure in the second period.

12. The method of claim 9 or 10, wherein the pressure in the first period is lower than the pressure in the second period.

13. The method of any one of claims 8-12, wherein the coated particulates are conveyed to the mold in a pod, a canister, a compartment, a sachet, a bag or a housing.

14. A system for forming a single-serve edible bar comprising:
a. a molding module;
b. means for subjecting the molding module to a predetermined pressure profile;
c. means for subjecting the molding module to a predetermined temperature profile;
d. means for loading and unloading the mold with a predetermined amount of particulate food;
e. a plurality of sensors, configured to communicate time, temperature and pressure; and
f. a processor in communication with the molding module, the means for subjecting the molding module to a predetermined pressure profile, the means for subjecting the molding module to a predetermined temperature profile, the means for loading and unloading the mold with a predetermined amount of particulate food, and the plurality of sensors, having a memory with a processor readable media thereon comprising a set of executable instructions configured to: load and/or unload the molding means; subject the molding means to the predetermined pressure profile; and subject the molding means to the predetermined temperature profile

15. The system of claim 14, wherein the molding means comprises an elongated housing with at least one movable section relative to the housing's longitudinal axis or transverse axis.

16. The system of claim 14, wherein the means for subjecting the molding module to a predetermined temperature profile comprises a heating element operably coupled to the housing, the heating element configured for heating and/or cooling the housing.

17. The system of claim 16, wherein the means for subjecting the molding module to a predetermined pressure profile comprises an actuator operably coupled to the at least one movable section of the housing.

18. The system of claim 17, wherein the processor is configured to increases the housing temperature at a rate represented by the formula: Tₜ=T₀+kₜ ln(t) and
wherein T₀ is between about 50° C. and about 125° C.,
while k is between about 50 min.⁻¹ and about 100 min.⁻¹.

19. The system of claim 18, wherein the processor is configured to subject the housing to a first pressure and temperature profile until receiving a load value from the plurality of sensors indicating a consolidation point, and altering the pressure and/or temperature.

20. A single-serve edible bar formed in the system of any one of claims 14-18.

21. The method of claim 1, wherein the period is between about 2.0 minutes and about 2.5 minutes.
